(19) United States
(12) Patent Application Publication
(10) Pub. No.: US 2011/0249115 A1
(43) Pub. Date: Oct. 13, 2011

(54) APPARATUS FOR CRACK DETECTION DURING HEAT AND LOAD TESTING

(76) Inventors: Marc Genest, Ottawa (CA); David Dudzinski, Ottawa (CA)

(21) Appl. No.: 13/072,074

(22) Filed: Mar. 25, 2011

Related U.S. Application Data
(60) Provisional application No. 61/282,828, filed on Apr. 7, 2010.

(51) Int. Cl. H04N 5/30; H04N 7/18

(52) U.S. Cl. 348/125; 348/E07.085; 348/E05.085

(57) ABSTRACT

Material testing under variable heat and load while continuously monitoring crack formation is provided using an apparatus that permits thermal control somewhat uniformly over a conductive sample, while permitting a controlled load to be applied to the sample in tensional or flexural modes. Thermographic imaging of a sample in situ within a standard thermo-mechanical fatigue (TMF) test rig or other heat and load test apparatus is used to detect and monitor cracks as they form. A 360° sample view is possible. Image analysis software may identify, count and/or characterize cracks. Thermographic images may be analyzed to determine a sample temperature, e.g. for temperature feedback control. Essentially passive thermography is used with an inductive heating coil that surrounds at least 60% of a length of the sample, with at least two windings, the windings having thickness and pitch so that at least half the sample is in view.

### CROSS-REFERENCE TO RELATED APPLICATIONS

This application claims the benefit of United States Provisional patent application U.S. Ser. No. 61/282,828 filed Apr. 7, 2010 the entire contents of which is herein incorporated by reference.

### FIELD OF THE INVENTION

The present invention relates in general to material testing under variable heat and load, and, in particular, to an apparatus for heat and load testing that permits thermal control somewhat uniformly over a conductive sample, while permitting a controlled load to be applied to the sample in tensional or flexural modes, wherein the apparatus permits continuous monitoring of crack formation.

### BACKGROUND OF THE INVENTION

Thermomechanical fatigue (TMF) is a standardized test used to determine a safe operating life for structural parts, especially those that are exposed to considerable temperature fluctuations when in use. Many engineering materials such as components of gas turbine engines are subjected to both high temperatures and mechanical loads. These loading conditions vary significantly during the start and stop cycles of the gas turbine, imposing both thermal and mechanical loads on the material. Throughout the life of the engine, cracks can develop in engine components and grow as a result of this thermo and mechanical fatigue. A common approach for the evaluation of fatigue, and the resulting material behaviour, is to idealize the conditions of a critical element on a uniaxial laboratory test specimen. The independent control and simultaneous variation of both temperature and mechanical strain fields on a test specimen is often referred to as a strain-controlled TMF test. Apart from TMF, there are a wide variety of testing that can be performed on parts that involve subjecting the parts independently to variable thermal conditions and variable load. It may be desirable to substantially uniformly heat test samples as well as to be able to produce a wide range of thermal conditions.

Various TMF test apparatus are known in the art. For example, Instron (Canton Mass.) sells components of a TMF apparatus. For example, their 8862 testing system features a 100 kN high stiffness precision aligned loading frame, and a single-ballscrew 100 kN electromechanical actuator. Their brochure [pod_tmf_REV1_{—}1103] shows a typical test system, and provides a schematic illustration of heat flow. High frequency induction heating is used to enable heating rates of up to 50° C. per second to a maximum temperature of 1000° C. The generator is capable of producing up to 10 kW in the frequency range of 50 to 200 kHz; and will tune itself to the optimum frequency for the application. The heating system is interfaced with a closed loop controller, with temperature measurement and feedback being provided by an optical pyrometer. This closed loop controller functions as a slave of the temperature control axis within the test controller. The generator may be run either directly from the front panel or from a temperature controller. The generator supplies power to the two-turn work coils, which surround the specimen. The work coils are mounted at the rear on a slide arrangement that eases the assembly of the specimen into the grips. Between the work coils, a high temperature precision extensometer is coupled to the part to measure strain throughout the test. The optical pyrometer is shown to measure a point on the specimen between the coils.

Crack inspections are done on such TMF apparatus by removing the part from the rig, and subjecting it to post-test crack evaluation, e.g. using optical or scanning electron microscopes, or acetate replication. Optical and scanning electron microscopes require significant investments, and skilled users. The most common technique used for crack inspection during a TMF test is cellulose acetate replication. This method has many advantages but the primary benefit is that the acetate replica forms a permanent record which can be referenced at a later time. As well, this technique can be used to document cracks as small as 5 μm [Swain, M. H. “Monitoring Small-Crack Growth by the Replication Method,” Small-Crack Test Methods, ASTM STP 1149, J. M. Larsen, and J. E. Allison, Eds., American Society for Testing and Materials, 1992, pp 34-56]. The primary disadvantages of acetate replication are that the procedure is labour intensive and cannot be automated. During replication the acetate can remove oxides from the surface of the specimen altering it. Importantly this can change the emissivity of the sample being evaluated, requiring re-calibration before returning the sample to the TMF apparatus, if surface measurements are used to control the temperature (e.g. using an infrared pyrometer).

Generally fatigue has been understood as a progression from formation of dislocations, which develop into persistent slip bands, which nucleate short cracks, which may grow, join, and lead to failure. This process is stochastic. Early fatigue crack growth behaviour is a crucial aspect to understanding the total fatigue life for many engineering applications. It is particularly important for understanding how thermo-mechanical stress impacts growth of cracks. Unfortunately, it is not possible to get an idea about the presence or state of development of cracks except by assigning numbers of cycles between the inspections, or by changes in the stress determined by the extensometer as a function of load. Typically, once the stress changes with the load, the part has fatigued to nearly the point of failure. The stochastic nature of the process makes the assignment unreliable. It is known that fatigue in similar samples progress at markedly different rates, even in tightly controlled environments. Either a cautious approach is used to avoid too much fatigue to provide the entry point to the study, and the test is stopped frequently and inspected, or the time and effort of repeated characterizations are avoided by increasing a risk that one or more of the samples will be fatigued beyond the starting point of the analysis. The expense and availability of the parts, skilled labour, time and equipment required to study development at key points in the process are practical issues that impact the decision, and in general this state of affairs impedes determinations of the properties of samples.

An array of mechanical fatigue apparatus are known in the art, and a wide variety of inspection techniques are known to be applied to them, even while the test is underway. It has been suggested to heat a point on a test sample and use thermographic imaging to determine cracks, using active thermography. Such relatively unconstrained systems are easily inspected as access to the sample along 6 of 8 sides are provided. For TMF and like apparatus that substantially uniformly heat the sample in an efficient manner, (i.e. locally heating the sample without heating the test rig) there is no such access provided.

One example of a mechanical (not thermo-mechanical) fatigue test employing active thermography is provided in United States patent application publication number US 2008/0310476 to Ummenhofer et al., which purportedly provides a method and device for determining a damaged state of a part, although there is a marked lack of detail in all respects. Ummenhofer et al. show a very schematic illustration of a part shown to be under a tensional load, which is said to be time varying. No equipment is shown for doing this, but, as the part is stated to be metal, and mechanical fatigue testing is performed resulting in microplastic deformations in the notched region, one would naturally expect that significant load bearing equipment would be required, but it is known that this equipment could leave 2 dimensions of the part exposed. According to Ummenhofer et al., an active excitation is applied to the part. This is illustrated in form of a wave. The wave appears to be narrowly focused on the part, which matches the preference for using a microscope lens on the notch of the part for thermographic inspection of small cracks. No other detectors are described or shown, including any extensometer. Depending on the special embodiment, the active excitation may involve microwaves, laser beams, ultrasound, mechanical and inductive excitations or else other forms. It is particularly mentioned that excitation in the so-called lock-in method is intended, and that it would also be particularly preferred if the active excitation of the part is formed completely or partly by the operating load of the part on site or if the active excitation of the part takes place by means of shakers and/or test apparatuses and/or ultrasound converters and/or mechanical operating loads and/or thermal excitation sources, inductive excitation sources and/or electromagnetic excitation sources and/or eddy current excitation sources. Furthermore Ummenhofer et al. teach imaging of only a sector of the part, so only heating of the sector would be necessary. Naturally Ummenhofer et al. would want the heat applied to minimally influence the mechanical fatigue properties of the part, as thermal fatigue contributions are generally unwanted for materials that are not thermally cycled, and as thermal cycling changes the nature of fatigue.

There is a need in the art for a technique that is applicable to uniformly heat a sample while providing a variable load, and to permit inspection of the sample concurrently, especially with a view to providing in situ crack detection and monitoring.

### SUMMARY OF THE INVENTION

Applicant has discovered, unexpectedly, that thermographic imaging can be provided of a sample in situ within a standard TMF test rig or like heat and load test apparatus to detect and monitor cracks as they form. Furthermore a 360° view of the part is possible using reflectors. The thermographic imaging system may be complemented with image analysis software for detecting a number and/or size of cracks in the sample, for determining a temperature of the sample, for example as a part of a temperature feedback control loop, and/or for load control.

Accordingly an apparatus for variable heat and load testing is provided, the apparatus comprising: a loading frame and actuator for applying a load to a conductive sample from two opposite ends of the sample; an inductive heater coil surrounding the sample extending over at least 60% of the extent of the sample between the two opposite ends, the coil consisting of at least two windings around the sample, the windings having a thickness, and a pitch, such that at least half the sample is in view along the extent of the coil; and a passive thermographic imaging system for producing a thermal map of the sample.

Also accordingly, a kit comprising two or more of the following is provided: an inductive heater coil for surrounding a conductive sample for heat and load testing, the coil extending over at least 60% of the extent of the sample between two opposite ends that are coupled to a loading frame and actuator, the coil consisting of at least two windings around the sample, the windings having a thickness and a pitch, such that at least half the sample is in view along the extent of the inductive heater coil; a passive thermographic imaging system adapted to image a conductive sample between the windings of an inductive heater coil as recited in a); and instructions for coupling two opposite ends of a conductive sample to a loading frame and actuator with a coil surrounding the sample as recited in a), and setting up a passive thermographic imaging system to image the sample.

The kit or apparatus may further comprise program instructions for: acquiring and displaying a thermographic image of the sample from the camera; processing data received from the thermographic imaging system to enhance defects; acquiring and analyzing a thermographic image to compute a number and length of microcracks; or acquiring and analyzing a thermographic image to compute a number and/or a length of microcracks, the number and/or length being supplied to a controller to alter a load applied on the sample and/or a temperature applied to the sample; acquiring and analyzing a thermographic image to compute a mean temperature of the sample, the mean temperature serving as feedback for a temperature control system that governs a power supply to the inductive heating coils. The program instructions may be designed for execution on a test controller, which may additionally be a part of the kit.

The kit or apparatus may further include a reflector for positioning within the field of view of the thermographic system to expose a part of the sample not otherwise in the field of view, such as a corner reflector which provides 360° view of the coil and sample.

Also accordingly a method is provided for monitoring cracks during heat and load testing, the method comprising: providing a conductive sample for testing, the sample having two opposing ends and body intermediate the ends; coupling the ends to respective grips of a loading frame and actuator for controlled application of a variable load to the sample; providing an inductive heating coil surrounding the sample for controlled supply of power for heating the sample, the coil extending over at least 60% of the extent of the sample between two opposite ends that are coupled to a loading frame and actuator, the coil consisting of at least two windings around the sample, the windings having a thickness and a pitch such that at least half the sample is in view along the extent of the inductive heater coil; and providing a passive thermographic imaging system to image the sample through the coil during the heat and load testing.

The passive thermographic imaging system provided may comprise a camera positioned and oriented such that its field of view covers the sample along the extent of the inductive heater coil; and may further comprise a reflector within the field of view of the camera for exposing a part of the sample not otherwise within the field of view.

A pyrometer for measuring a temperature applied to the sample during testing may be provided, and may comprise a photodetector focused on a high emissivity point on the sample. Measured temperature may serve as feedback for a temperature control system that governs a power supply to the coil, which may be a temperature control subsystem of a test controller.

Finally, a test controller for a heat and load test apparatus is provided, the heat and load test apparatus includes a loading frame and actuator for applying a load to a conductive sample from two opposite ends of the sample, and an inductive heater coil surrounding the sample extending over at least 60% of the extent of the sample between the two opposite ends, the coil consisting of at least two windings around the sample, the windings having a thickness, and a pitch, such that at least half the sample is in view along the extent of the coil; the test controller adapted to receive thermographic images of the sample during the test, compute a number of cracks in the sample and/or a length of a crack in the sample from the thermographic images, and modify the application load and/or heat to the sample in response thereto.

An extensometer for measuring a strain of the sample during testing may be provided, and may comprise two arms coupled to the sample, the arms extending through spaces between respective windings of the coil, and extensometer measurements may be provided to a test controller for determining a strain as a function of load.

Further features of the invention will be described or will become apparent in the course of the following detailed description.

### BRIEF DESCRIPTION OF THE DRAWINGS

In order that the invention may be more clearly understood, embodiments thereof will now be described in detail by way of example, with reference to the accompanying drawings, in which:

FIG. 1 is a schematic illustration of a heat and load test apparatus in accordance with a first embodiment of the invention;

FIG. 2 is a schematic illustration of a heat an load test apparatus in accordance with a second embodiment of the invention, showing a number of optional features added to the embodiment of FIG. 1;

FIG. 3 is a schematic illustration of how induction heated thermography operates to detect surface and subsurface cracks in metals;

FIGS. 4a,b are two images showing an experimental heat and load test apparatus used for demonstrating the utility of the present apparatus;

FIG. 5 is an image of a test sample automatically stopped after a 50% load drop;

FIGS. 6a,b are images of an acetate replica, and the original part according to prior art characterization techniques;

FIGS. 7a,b are thermographs of the sample taken during the test from front and reflected views, respectively at ambient temperature;

FIGS. 7c,d are sets of thermographs of a relatively crack-free and large crack bearing surface at respective temperatures; and

FIG. 8 shows for comparison a raw thermographic image, and an image processed version that augments the features and improves crack length determination.

### DESCRIPTION OF PREFERRED EMBODIMENTS

An in-situ inspection technique is provided using induction thermographic imaging during heat and load testing. Essentially passive thermography is performed as the heating is provided for the heat and load testing, and is provided substantially uniformly across the sample by an inductive heater coil that surrounds the sample.

FIG. 1 schematically illustrates a heat and load test apparatus in accordance with an embodiment of the invention. The heat and load test apparatus includes a sample 10 which is shown to be an elongated part, which would typically have a notched region to ensure cracking in a more localized region that can be monitored. A shape of the sample 10 could be of substantially any other shape. Two opposite ends of the sample 10 are held by respective grippers 12a of a loading frame and actuator 12 which includes one or more actuators 12b, such as pneumatic, hydraulic, or ball screw or other electromechanical actuators. The loading frame and actuator 12 is schematically shown and may have an actuator that applies a force on one gripper 12a from a hard point further distant from the sample, provided the opposite gripper 12a is mounted to a hard point, for example. Ideally the load frame and actuator 12 provides substantially no obstruction to the extent of the sample 10 between the grippers 12a. While the specific load frame shown generally permits extensive and/or compressive forces to be applied to the sample 10 as the force application is concentric with a center axis of the sample 10, it will be evident that torsional, or shear, or combinations of any of the above forces could equally be applied using the same equipment with a part having a different geometry, or gripped in different ways, and/or with substituted equipment.

The load frame and actuator 12 has a control interface 14 that may permit manual control of the load during the test, as well as for control by another computer. For example, for TMF testing, control over a load cycle period and amplitude would be required. Typically such control interfaces 14 include feedback from strain gages between the actuators 12b and the grippers 12a for determining a force applied to the grippers 12a to accurately execute a pre-programmed force, or a force that is indicated from the control interface 14.

A temperature of the sample 10 is controlled by an induction heater coil 16 that is chosen to provide adequate view of the sample 10, while providing sufficient proximity and power for effective heating within the thermal range required for the testing. Windings of the coil 16 are preferably formed of a thin, self supporting conductor that is minimally coated to provide a thinnest gage of wire that minimizes occlusion of the sample 10. While the coil 16 is shown having a uniform pitch, and uniform radius, it will be appreciated that uniform heating is generally important and further that it would only be in the notched region of the sample that minimal occlusion by the coil 16 would be desired, and thus other designs may be preferred. Cooling of the sample 10 may be provided by cooling jets, or by ambient cooling, and may be accelerated or impeded by controlling air flow around the sample 10 in a manner known in the art. The coil 16 is coupled electronically to a power supply and regulator 18 that controls the alternating current (AC) power applied through the coil 16. The coil 16 emits magnetic fields that induce electric current within the sample 10, which resistively heats the sample 10, and induces secondary currents, that if sufficiently strong, effect heating. Since induction heating is based on eddy current excitation, it can only be applied to electrically conductive materials.

A thermal camera 20 is provided for imaging the sample during the test to determine a number, length and/or width of cracks in the sample 10. The position, orientation, and optics of the camera 20 are chosen so that the surface of the sample 10 is within the field of view of the camera 20. Infrared (IR) thermography is a contactless technique that determines the surface temperature distribution of an object by observing its infrared emissions. Typically, the IR emissions are measured using an IR camera. The technique is considered passive if no additional energy source is applied to the sample, whereas it is considered active when external energy is needed such as a heat source, flash light, mechanical vibration or electromagnetic excitation. Local heating occurs at flawed locations due to their higher electrical resistance resulting in a temperature differential.

FIG. 2 schematically illustrates a number of alternative features that may be added to the heat and load test apparatus. Elements 10-20 described above retain the same functionality and characteristics as described above, but may additionally have features or capabilities not expressly noted in regard to FIG. 1.

A first improvement over FIG. 1 is provided by permitting a 360° view of the sample by providing a reflective surface 22, which may consist of a pair of mirrors meeting at an angle (as shown) that advantageously has no blind spot. As the coil 16 illustrated is helical, and has a pitch far greater than the thickness of the winding, at least one side of the sample 10 is in view all along the extent of the sample 10 between the grippers 12a using this technique. Other reflection schemes and optics could alternatively be used.

A mechanical extensometer 24 may optionally be used, and is typically used in TMF testing, to determine a strain of the sample 10 under the load. The measured strain may be relayed to the control interface 14, for example when the test requires control of a given amount of strain of the part, and not a given load, but is typically logged by a test controller 26 for analysis. It is also currently well known to use a pyrometer, such as an optical pyrometer 28 for determining a temperature of the sample. Often a high emissivity coating is applied to a particular part of the sample in view of the optical pyrometer 28, in order to accurately gage the temperature of the sample 10. Complexities in the thermo-electro-mechanical behaviour of the sample 10 typically makes it difficult to predict the temperature of the sample using the power applied to the coil 16, and the resistance thereto. The temperature readings would typically be provided to a temperature control system that governs the coil, as well as any cooling system. The temperature control system may be an external processor, may be provided as part of the power supply and regulator 18, or may be provided as a subroutine of the test controller 26.

A considerable advantage of the present invention is that thermographic imaging data can be used to automate heat and load testing, and vary the heat and/or load applied with a length of a largest crack, a number of cracks, a total length of the cracks, a maximum width of a crack, a change in thermal hysterisis, or any of the above in combination with a load drop change, number of cycles (if load or heat is cycled regularly, or a duration of the test and/or a total or mean temperature and or load and/or rate of change thereof), or the specific stress and/or temperature applied during a particular reading. Applicant has found that a good approximation to high resolution imaging of the sample 10 and of acetate replication can be provided by thermography, which is the only technique of the three that is available during the heat and load testing.

Specifically an image analysis processor 30 is provided for receiving image data from the thermal camera 20. The image data may be processed to remove artifacts, or noise, or to otherwise improve the clarity or definition of the cracks. The image analysis processor 30 may also compute any of the above-noted features of the thermal variations (in space and time) that identify cracks. An indictor of the thermal variations or a programmed response thereto may be forwarded directly to the power supply and regulator 18, and/or to the control interface 14 to vary the applied temperature and/or load applied to the sample. For example, when it is desirable to achieve a desired minimum crack length or a number of cracks per unit area, or a minimum number of cracks having a given mean length, followed by gentler test conditions, the desired state can be selected by characterizing the cracks, followed by selecting how the program will be modified. This includes stopping the test, or changing the thermal or mechanical properties of the test.

The image analysis processor 30 may also compute a mean temperature or a peak temperature of the sample 10, and forward this to the temperature control system for effecting a feedback signal.

A serial bus is schematically illustrated for supporting communications between the components described above, although it will be appreciated that there are a variety of equivalent communications equipment that are generally provided depending on the hardware capabilities and expediency.

The principle of operation of thermography utilized here is similar to that of induction thermography, also known as eddy current thermography [2] or inductive thermography [3]. This is an active form of thermography where an inductive electromagnetic coil is used as a source of energy to heat the specimen for inspection. As current circulates through the inductive coil, secondary currents are induced within the specimen. These currents are resisted to various degrees, depending on the sample electrical properties, and heat-up in the sample due to the Joule heating. Relatively greater local heating occurs at flaws due to their higher electrical resistance, resulting in a temperature differential. Accordingly rates of heating or cooling, maximum temperatures, and various other measures can be used to identify defects in this manner. In typical induction heating thermography only a small part of the sample is heated.

Eddy currents decay exponentially below the surface [3] and their penetration depth (which limits the depth of the defect that can be detected), is determined by:

$$δ = \sqrt{\frac{1}{{πσμμ}_{0} f}}$$

where σ is the specimen's electrical conductivity, μ its relative permeability, μ₀ is the permeability of vacuum, and f is the coil excitation frequency. Typical penetration depth at different excitation frequencies for steel varies with frequency of excitation from 1-10⁵ Hz between ˜0.02-2 mm, and typical nickel alloys are consistently about one order of magnitude higher of penetration (i.e. ˜0.2-20 mm). Limited penetration into these metals is possible. A desired temperature of a metallic sample can be achieved with a variety of frequency and amplitudes, or from combinations of frequencies at respective amplitudes. Thus it is possible to independently choose a depth or range of depths of penetration while still inductively heating the sample to the required temperature, within the limits of the coil, power supply, and regulator. Induction thermography can therefore selectively image subsurface defects at a given depth range, exclusively image surface defects, or image both without discrimination. It is also possible to alternate heating intervals with different frequencies to maintain a same temperature or temperature variation, while selectively exciting different depths. In such a case alternating images may reveal defects at different depths. It is also important to select the correct frequency for the flaw of interest, as illustrated in FIG. 3, and described in [1].

FIG. 3 is a schematic illustration of how induction heating thermography operates to detect surface and subsurface cracks in metals, as explained in [1]. Excitation using low frequencies can fail to detect surface cracks, while excitation using high frequencies can fail to detect subsurface cracks. Exciting with a range of frequencies can result in detection of both surface and subsurface cracks, which will be indistinguishable. Exciting at one set of frequencies followed by another set of frequencies in separate time intervals can permit equivalent thermal induction but provide for thermographic imaging at the respective depths.

### EXAMPLES

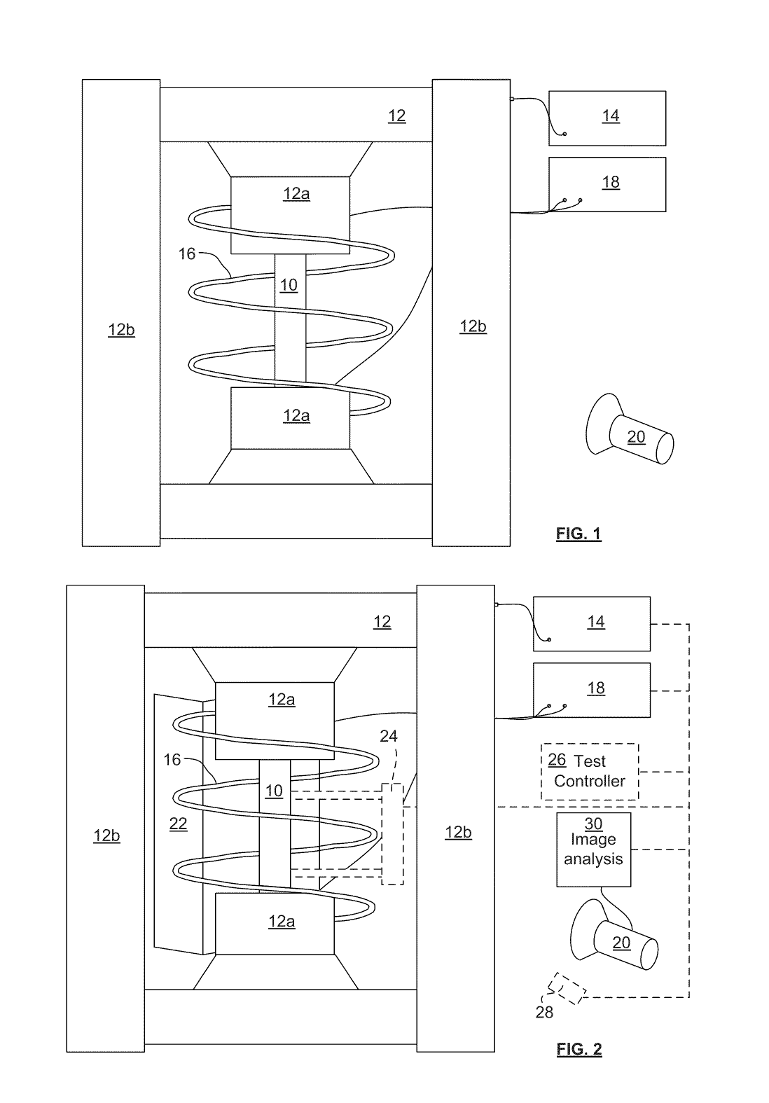

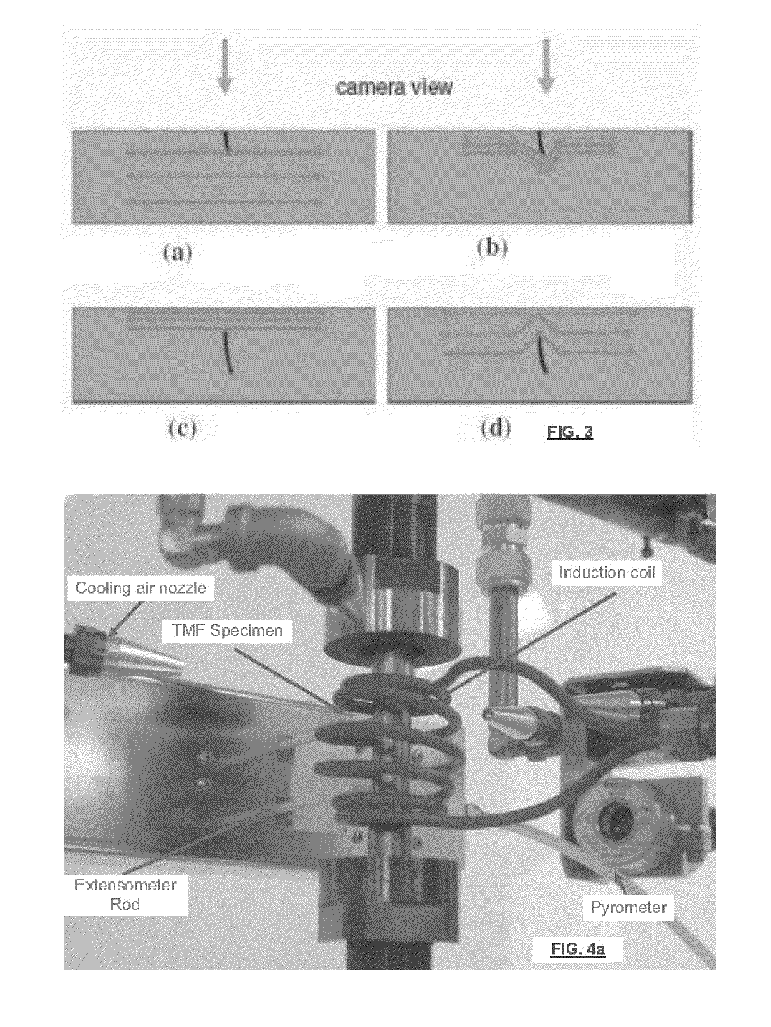

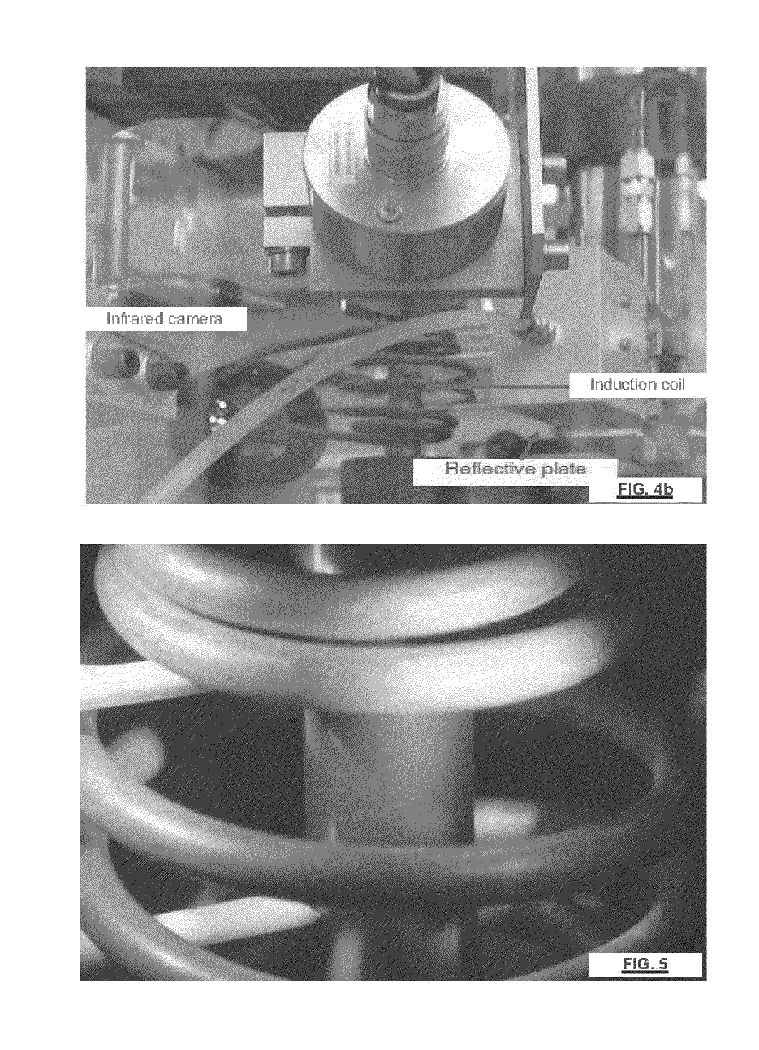

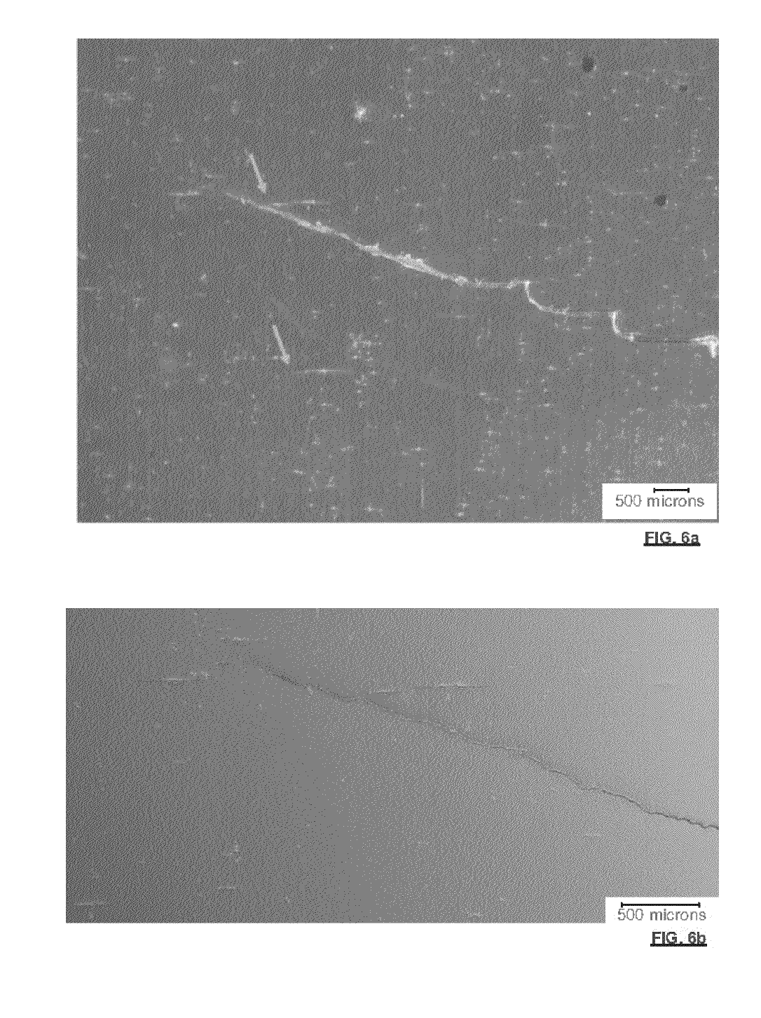

FIGS. 4a,b are two images showing an experimental heat and load test apparatus used for demonstrating the utility of the present invention. A MTS model 810 uniaxial servo-hydraulic test machine with a 100 kN load capacity was used as the load frame and actuator, to apply mechanical loading during the TMF test. The thermal loading was induced with an inductive helical coil powered by an Ameritherm Novastar 5 kW frequency generator. The strain was measured using a MTS model 654.54.11F high-temperature axial extensometer, while the temperature was measured using a Mikron MiGA5 infrared pyrometer. The control system consisted of a MTS model 493.01 digital controller running MTS 793 system software which was used for closed-loop control of both strain and temperature, and open-loop control of cooling air supplied to the sample.

The TMF test sample was machined from an inconel alloy. The sample had a length of ˜4″, a ˜½″ diameter. Prior to starting the TMF test, two black-body targets used for the infrared temperature measurements were painted on the specimen. The targets have a reduced susceptibility to emissivity changes and therefore assisted in the reduction of temperature variation throughout the TMF test period.

IR thermography was carried out using a FLIR SC3000 infrared camera. This camera is based on quantum well infrared photo detector (QWIP) that has a focal plane array detector of 320×240 elements, a thermal sensitivity of 20 mK at 30° C. and a spectral response in the long-infrared region (8 to 9 μm). The IR camera was connected to a laptop via a PC card cable. The visualisation and acquisition of the thermal images were performed on the laptop using a program developed at NRC-IAR.

FIG. 5 is an image of a test sample after over 10,000 cycles, the test having automatically stopped once a 50% load drop condition was detected. This condition indicates imminent specimen failure and is automatically done by the control system to prevent potential damage to both the specimen and induction coil. The image was magnified and illustrates the problems with visibility, including reflections and occlusions. This image was taken with a conventional digital camera once the sample cooled to ambient temperatures. Nonetheless the image shows a dominant crack surrounded by multiple smaller cracks within the imaged section of the sample.

Acetate replicas were taken of the sample. The replication procedure begins when the sample has cooled to room temperature. A percentage static load of the last cycle peak load is applied to ensure that any cracks present are opened. The surface of the sample is cleaned with reagent grade acetone and a cellulose acetate section, 127 μm in thickness, is applied to the imaged section of the sample. Pressure is applied to the acetate and, in combination with capillary action, the acetate material is drawn towards the sample surface. The acetone softens the acetate surface which can then easily conform to the surface geometry, including any cracks. After about 3 minutes, the acetate dries out forming the replica. The replica is removed from the sample, sandwiched between 2 glass slides, and labeled. Typically half of the circumferential area is captured with a single replica, therefore the above mentioned process is repeated to capture the complete imaged section of the sample. The replica was then analyzed using a low-power microscope.

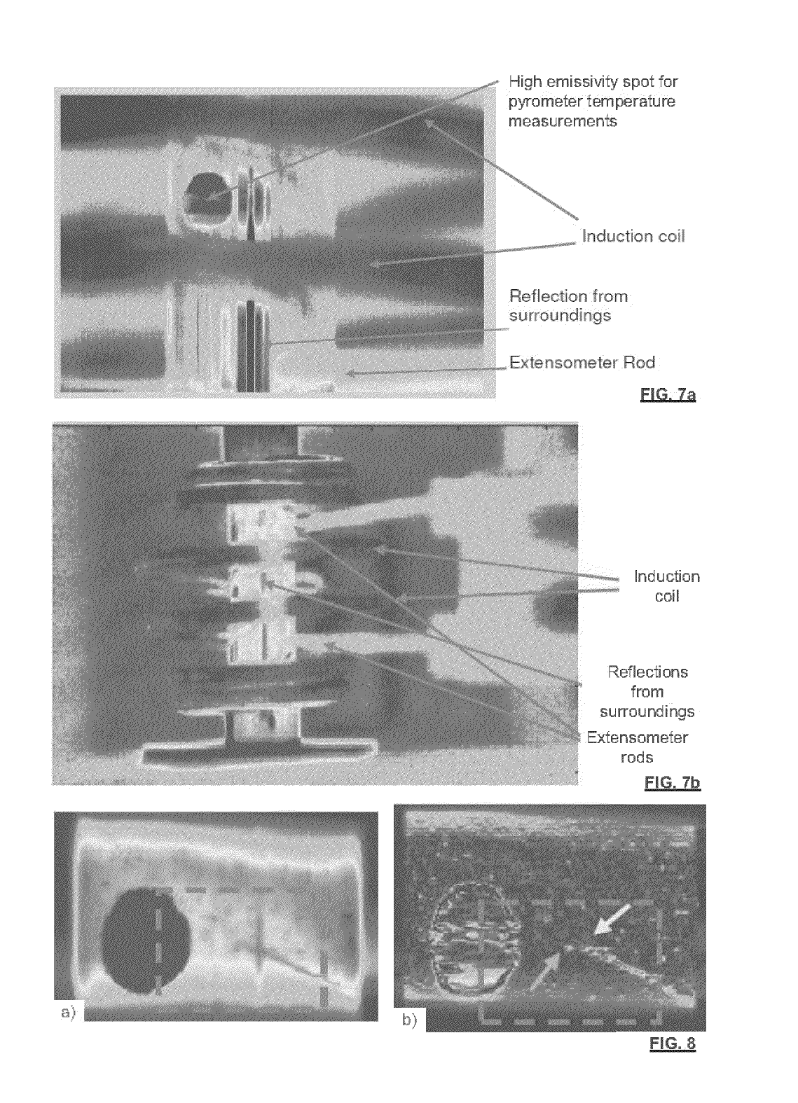

From images of the replica, the crack was determined to have a length of 14.4 mm (0.567 in) and was primarily in the back of the specimen (opposite the camera). Other acetate replicas were also made of the sample. A higher magnification of the crack-tip on the left side of the dominant crack was shown in FIG. 6a. This image shows multiple cracks.

A surface investigation of the sample shown in FIG. 6b was done using a Philips Scanning Electron Microscope (SEM), model XL30-SFEG. Again multiple images were taken and they agree well with the acetate replications. Multiple crack nucleation sites with the majority having a crack length under 500 μm, were observed. A SEM image of the left side of the dominant crack is shown in FIG. 6b.

Thermographs were obtained from a first position at room temperature and then at the different temperature steps. After the first set of inspections, the IR camera was moved to a second area of the sample. Thermographs obtained at the second location at low-temperature and at elevated temperatures were obtained. To complete the IR inspection, the area with a crack was then re-inspected using an indirect line of sight, using a reflective plate. There is a limit to the field of view as a result of both the physical constraints of the TMF test setup and the proximity of the IR camera to the specimen. This resulted in a lower spatial resolution compared to images obtained previously using the direct imaging technique. Nonetheless, the presence of the crack was visible.

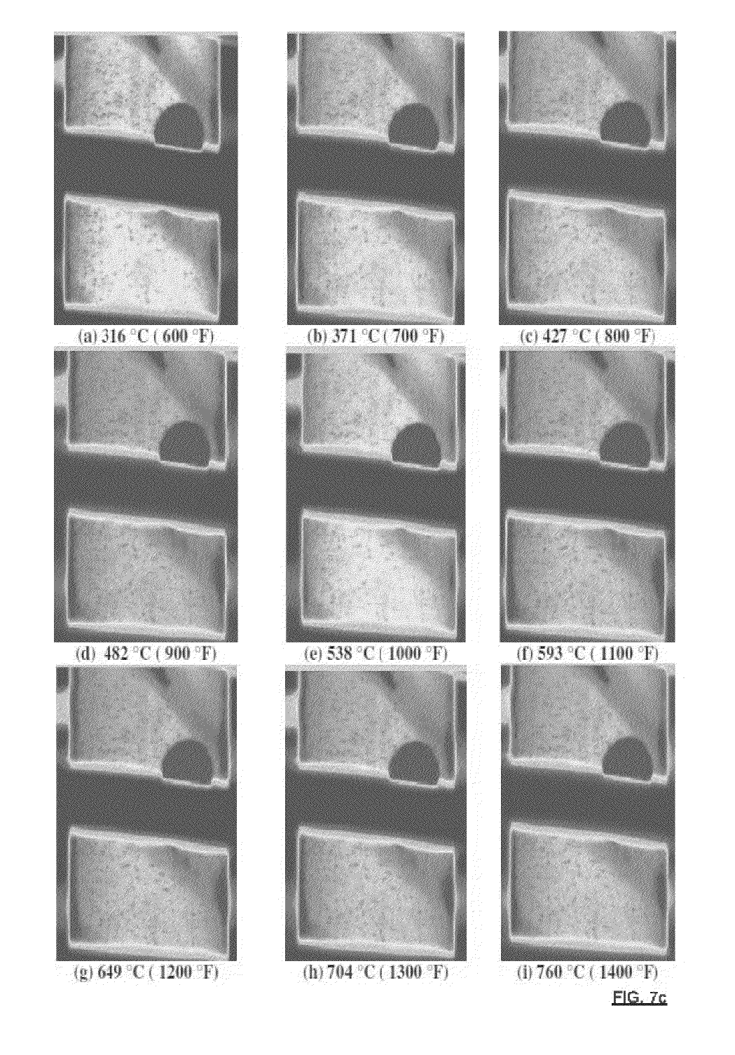

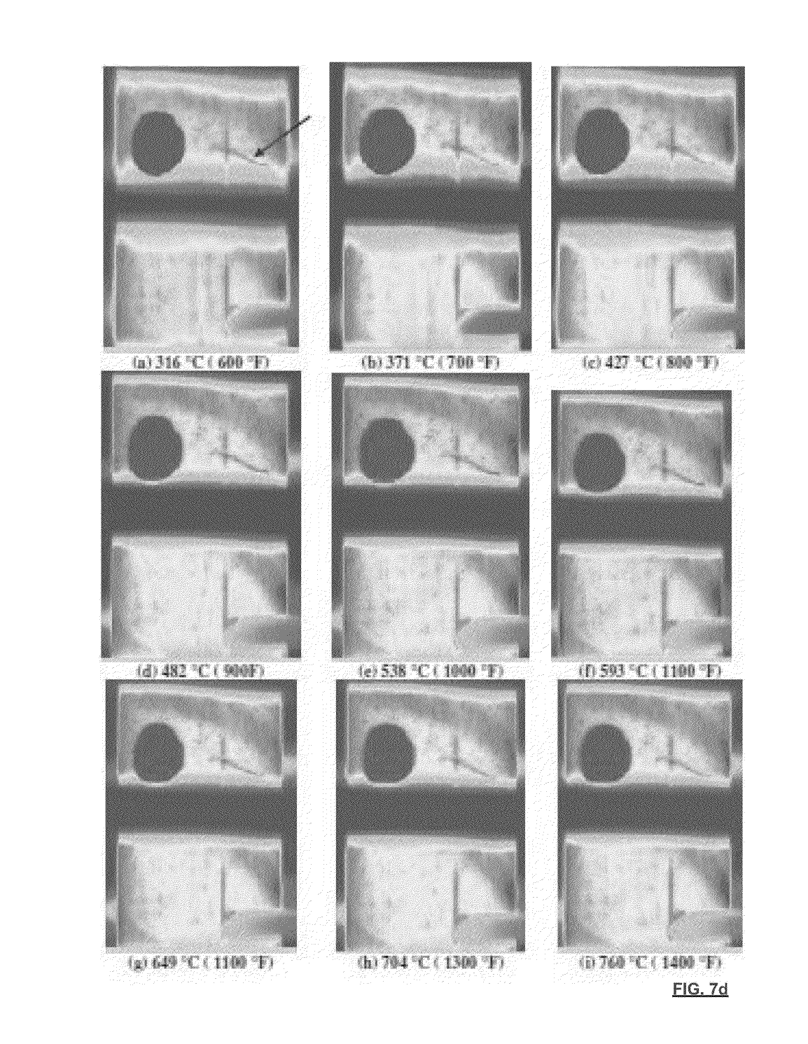

For example, thermographs of the sample taken at room temperature and at a higher temperature are shown in FIGS. 7a,b,c,d. The room temperature images (FIG. 7a,b) show several reflections of the surroundings. The high emissivity spot is visible in a reflected image in FIG. 7b, demonstrating that thermographs can be taken indirectly. At elevated temperatures (FIG. 7c,d), the emissivity of the specimen increases and so the reflections from the surroundings are reduced, and the presence of cracks are revealed.

FIGS. 7c.d are thermographic images of the sample taken during the test from the first and second locations, respectively. Inspections were performed for a range temperature varying between 260° C. (500° F.) and 760° C. (1400° F.) with a step increment of 56° C. (100° F.), while zero load was maintained. Induction heating (eddy current excitation) was performed using frequencies in the range of 50 kHz to 485 kHz. As such, the cracks seen are likely a mix of surface and subsurface cracks. It will be appreciated that by selectively choosing these frequencies, response from different depths can be highlighted. The measurements were carried out under static condition, i.e. the load and the temperature were constant during the acquisition of the IR images. For each temperature step, 20 thermal images were acquired. The thermographs demonstrate that temperatures from 600-1400° F. are suitable for rendering cracks in situ using thermography, and that all sides of a sample of regular shape, can be viewed.

Dark, substantially horizontal, bands around the centre of each image in FIGS. 7c,d are the relatively cool coil loops. Lighter, slightly pointed bands near the bottom left corner, and also substantially horizontal, are part of the extensometer. The dark, nearly circular spots are the high emissivity target. There are shading artifacts in most of the images, as well as vertical lines in FIG. 7d that are due to the sample geometry and emissivity (similar to “gloss” in optical images). A crack is clearly present and pointed by an arrow in FIG. 7d(a). Small dark spot speckling in the images are locations of surface and subsurface cracks. These have a pattern similar to that obtained by SEM and acetate replica.

FIG. 8 shows a raw thermograph a) and a processed thermograph b) that facilitates identification and characterization of cracks. Thermograph a) was taken by the direct method, although thermographs taken by the indirect method had the greater need for image enhancement. To enhance the crack visibility, image processing techniques were applied. Image processing techniques can, evidently, significantly improve data interpretation. Applicant examined two simple processing techniques: image subtraction and absolute value of horizontal gradient image processing [4], and both were shown to improve contrast and facilitate identification of cracks in comparison with the raw image. It was the latter technique used to produce thermograph b).

In the raw thermograph a), the smaller cracks are indiscernible as they appear to merged into the dominant crack. After image processing b) however, the smaller cracks become more visible. The basic image processing investigation showed that it is not necessary to process images from the direct field of view to determine the crack length, but it does enhance crack visibility. However, for the indirect field of view method, image processing may be necessary for small crack detection, depending on the resolution of the IR camera, and the field of view.

The induction thermography inspection was carried out at several temperatures and shows that the temperature used for the TMF test does not influence the crack detection capability. It is demonstrated that induction thermography can detect cracks in the order of 200 μm and has potential for quantifying the crack length. It is also demonstrated that a reflective plate can be used to inspect areas on the specimen that are not in direct view of the thermal imaging equipment.

The results obtained by induction thermography were compared to those obtained via traditional acetate replication method and post-test scanning electron microscope (SEM) evaluation, and the comparison is favourable.

Crack length measurements were performed on the dominant crack. From the indirect induction thermograph, the overall crack length of the dominant crack was found to be 1.14 mm. By direct thermography the crack was measured to be 0.87 mm, with the SEM image it was found to be 0.82 mm, and with the acetate replica image, the length was found to be 0.88 mm. The uncertainty of the indirect induction method was higher because of a lower spatial resolution of the image. It is considered that at least for cracks having dimensions as high as 0.5 mm, the present apparatus can determine the presence of cracks and gage their lengths. Furthermore, there are commercially available thermal cameras having higher resolution than the 320×240 elements, and accordingly it would be expected that higher still resolution imaging will serve to detect finer details with greater accuracy.

The direct inspection thermography images show the presence of many small features over the sample. These small features correspond to small cracks (in the order of 500 μm or smaller) from acetate replica images and SEM imaging. The influence of the sample temperature was found to be negligible for temperatures between 260° C. (500F) and 760° C. (1400F). Thus the temperature cycling employed in standard TMF testing will unlikely affect the inspection results. It could still be useful when using cyclic heating to enhance the crack detection through a lock-in method of image processing [5]. The lock-in method makes use of the signal periodicity to filter a signal with a narrow band corresponding to the period of the signal of interest, to increase the signal-to-noise ratio.

The importance of image processing has been shown. Smaller cracks are observed near the dominant crack in the processed images that are not discernible in the raw images.

One limit for induction thermography during a TMF test is that the inductive coil can partially or entirely block the view of the crack, for the IR camera field of view. This effect can be mitigated by combining results from different fields of view as well as further development and optimization of the camera's position. A majority of the surface of the sample within the imaged region is in view using the apparatus shown, and greater visibility can be provided by reducing a thickness of the windings of the coil, and/or by increasing the winding pitch, and also by varying a radius of the coil windings and a distance from the IR camera to the windings. For many applications, the present view of the sample is expected to be substantially representative of the crack distribution across the sample's surface.

Other advantages that are inherent to the structure are obvious to one skilled in the art. The embodiments are described herein illustratively and are not meant to limit the scope of the invention as claimed. Variations of the foregoing embodiments will be evident to a person of ordinary skill and are intended by the inventor to be encompassed by the following claims.

### REFERENCES

The contents of the entirety of each of which are incorporated by this reference.
[1] Zenzinger, G. et al., “Thermographic Crack Detection by Eddy Current Excitation,” Nondestructive Testing and Evaluation, vol. 22, 2007, pp. 101-111;
[2] Oswald-Tranta, B. “Thermo-Inductive Crack Detection,” Nondestructive Testing and Evaluation, vol. 22, 2007, pp. 137-153;
[3] Riegert, G., Zweschper, T., Busse, G., “Lockin Thermography with Eddy Current Excitation”, QIRT Journal Vol I, No 1, 2004, Cachan Cedex: Lavoisier, pp. 21-31; and
[4] Russ, J. C, “The Image Processing Handbook”, 2^{nd} Edition, CRC Press, Florida, 1995.

1. An apparatus for variable heat and load testing comprising:
a loading frame and actuator for applying a load to a conductive sample from two opposite ends of the sample;
an inductive heater coil surrounding the sample extending over at least 60% of the extent of the sample between the two opposite ends, the coil consisting of at least two windings around the sample, the windings having a thickness, and a pitch, such that at least half the sample is in view along the extent of the coil; and
a passive thermographic imaging system for producing a thermal map of the sample.

2. The apparatus of claim 1 wherein the thermographic imaging system comprises:
a camera positioned and oriented such that its field of view covers the sample along the extent of the coil;
a camera positioned and oriented such that its field of view covers the sample along the extent of the coil and a reflector within the field of view of the camera for exposing a part of the sample not otherwise within the field of view;
a camera positioned and oriented such that its field of view covers the sample along the extent of the coil communicatively coupled to an image processor adapted to display a thermographic image of the sample;
a camera positioned and oriented such that its field of view covers the sample along the extent of the coil communicatively coupled to an image processor adapted to process image data received from the camera to enhance defect detection;
a camera positioned and oriented such that its field of view covers the sample along the extent of the coil communicatively coupled to an image processor adapted to process image data received from the camera to compute a number and/or length of microcracks in the sample;
a camera positioned and oriented such that its field of view covers the sample along the extent of the coil communicatively coupled to an image processor adapted to process image data received from the camera to compute a number and/or length of microcracks in the sample, the image processor adapted to forward the number and/or length of microcracks to a test controller, which may alter a load applied on the sample and/or a temperature applied to the sample;
a camera positioned and oriented such that its field of view covers the sample along the extent of the coil communicatively coupled to an image processor adapted to process image data received from the camera to determine a mean temperature of the sample, the image processor adapted to forward the mean temperature to a test controller, which may alter a load applied on the sample and/or a temperature applied to the sample; or
a camera positioned and oriented such that its field of view covers the sample along the extent of the coil communicatively coupled to an image processor adapted to process image data received from the camera to determine a mean temperature of the sample, the image processor adapted to forward the mean temperature serving as feedback for a temperature control system that governs a power supply to the inductive heating coils.

3. The apparatus of claim 1 further comprising:
an extensometer;
a pyrometer;
a test controller for controlling the actuator and power supply to the coil;
a test controller for controlling the actuator and power supply to the coil, adapted to acquire from the thermographic imaging system, and display, a thermographic image of the sample;
a test controller for controlling the actuator and power supply to the coil, adapted to process data received from the thermographic imaging system to enhance defects;
a test controller for controlling the actuator and power supply to the coil, adapted to process a thermographic image to compute a number and/or length of microcracks in the sample;
a test controller for controlling the actuator and power supply to the coil, adapted to process a thermographic image to compute a number and/or length of microcracks in the sample which is used as feedback to control the heat and load test;
a test controller for controlling the actuator and power supply to the coil, adapted to process a thermographic image to compute a number and/or length of microcracks in the sample which is used as feedback to control the heat and load test by altering a load applied on the sample and/or a temperature applied to the sample; or
a test controller for controlling the actuator and power supply to the coil, adapted to process a thermographic image to analyze a thermographic image of the sample to measure a mean temperature of the sample, the mean temperature serving as feedback for a temperature control subsystem that governs a power supply to the inductive heating coils.

4. A kit comprising two or more of:
a) an inductive heater coil for surrounding a conductive sample for heat and load testing, the coil extending over at least 60% of the extent of the sample between two opposite ends that are coupled to a loading frame and actuator, the coil consisting of at least two windings around the sample, the windings having a thickness and a pitch, such that at least half the sample is in view along the extent of the inductive heater coil;
b) a passive thermographic imaging system adapted to image a conductive sample between the windings of an inductive heater coil as recited in a); and
c) instructions for coupling two opposite ends of a conductive sample to a loading frame and actuator with a coil surrounding the sample as recited in a), and setting up a passive thermographic imaging system to image the sample.

5. The kit of claim 4 further comprising one or more of:
d) program instructions for acquiring and displaying a thermographic image of the sample from the camera;
e) program instructions for processing data received from the thermographic imaging system to enhance defects;
f) program instructions for acquiring and analyzing a thermographic image to compute a number and length of microcracks;
g) program instructions for acquiring and analyzing a thermographic image to compute a number and/or a length of microcracks, the number and/or length being supplied to a controller to alter a load applied on the sample and/or a temperature applied to the sample;
h) program instructions for acquiring and analyzing a thermographic image to compute a mean temperature of the sample, the mean temperature serving as feedback for a temperature control system that governs a power supply to the inductive heating coils; and
i) a test controller for effecting program instructions according to any one or more of d)-h.

6. A method for monitoring cracks during heat and load testing, the method comprising:
providing a conductive sample for testing, the sample having two opposing ends and body intermediate the ends;
coupling the ends to respective grips of a loading frame and actuator for controlled application of a variable load to the sample;
providing an inductive heating coil surrounding the sample for controlled supply of power for heating the sample, the coil extending over at least 60% of the extent of the sample between two opposite ends that are coupled to a loading frame and actuator, the coil consisting of at least two windings around the sample, the windings having a thickness and a pitch such that at least half the sample is in view along the extent of the inductive heater coil; and
providing a passive thermographic imaging system to image the sample through the coil during the heat and load testing.

7. The method of claim 6 wherein the passive thermographic imaging system provided comprises:
a camera positioned and oriented such that its field of view covers the sample along the extent of the inductive heater coil; or
a camera positioned and oriented such that its field of view covers the sample along the extent of the inductive heater coil and a reflector within the field of view of the camera for exposing a part of the sample not otherwise within the field of view.

8. The method of claim 6 further comprising:
providing an extensometer for measuring a strain of the sample during testing;
providing a mechanical extensometer for measuring a strain of the sample during testing comprising two arms coupled to the sample, the arms extending through spaces between respective windings of the coil; or
providing an extensometer for measuring a strain of the sample during testing, the extensometer measurements being provided to a test controller for determining a strain as a function of load.

9. The method of claim 6 further comprising:
providing a pyrometer for measuring a temperature applied to the sample during testing;
providing a pyrometer for measuring a temperature applied to the sample during testing, the pyrometer comprising a photodetector focused on a high emissivity point on the sample;
providing a pyrometer for measuring a temperature applied to the sample during testing, the temperature serving as feedback for a temperature control system that governs a power supply to the coil; or
providing a pyrometer for measuring a temperature applied to the sample during testing, the temperature serving as feedback for a temperature control subsystem of a test controller that governs a power supply to the coil.

10. A test controller for a heat and load test apparatus that includes a loading frame and actuator for applying a load to a conductive sample from two opposite ends of the sample, and an inductive heater coil surrounding the sample extending over at least 60% of the extent of the sample between the two opposite ends, the coil consisting of at least two windings around the sample, the windings having a thickness, and a pitch, such that at least half the sample is in view along the extent of the coil; the test controller adapted to receive thermographic images of the sample during the test, compute a number of cracks in the sample and/or a length of a crack in the sample from the thermographic images, and modify the application load and/or heat to the sample in response thereto.
